(19) United States
(12) Patent Application Publication
(10) Pub. No.: US 2026/0303137 A1
(43) Pub. Date: Oct. 1, 2026

(54) TRANSMITTER, RECEIVER, COMMUNICATION SYSTEM AND COMMUNICATION METHOD FOR MIMO COMMUNICATION ENABLING MITIGATION OF AN INTERFERING TRANSMITTER

(71) Applicant: ETH ZURICH, Zurich (CH)

(72) Inventors: Christoph Emanuel STUDER, Zurich (CH); Gian Luca MARTI, Zurich (CH)

(21) Appl. No.: 19/478,188

(22) PCT Filed: Apr. 18, 2024
(86) PCT No.: PCT/EP2024/060565

§ 371 Date: Oct. 23, 2025

(30) Foreign Application Priority Data
Apr. 25, 2023 (EP) 23169688.1

(51) Int. Cl. H04B 1/12; H04B 7/0413; H04K 3/00

(52) U.S. Cl. CPC H04B 1/12; H04B 7/0413; H04K 3/228

(57) ABSTRACT

One or more transmitters and a receiver of a MIMO communication system enable mitigation of a jammer. The one or more transmitters are configured to generate an embedded signal by embedding a transmit signal with a linear time-domain transformation onto a secret subspace based on a secret unitary matrix which is accessible to the transmitters and the receiver, and to transmit the embedded signal via MIMO communication having a legitimate channel matrix to the receiver The receiver is configured to receive a receive signal which includes the embedded signal and to process the receive signal for determining an estimate of the transmit signal by extracting the transmit signal from the secret subspace (subC) using the secret unitary matrix.

### FIELD OF THE INVENTION

The present invention relates to a transmitter, a receiver, a communication system and a communication method for MIMO (MIMO: multiple input multiple output) communication enabling mitigation of an interfering transmitter, in particular enabling mitigation of a jammer.

### BACKGROUND ART

Radio jamming is the deliberate jamming, blocking or interference with legitimate wireless communications. Jammers transmit radio signals that degrade or block legitimate wireless communications. Mitigation of a jammer (or jammer mitigation) has the purpose to eliminate or to reduce interference of the jammer with legitimate wireless communications. Multi-antenna MIMO signal processing (MIMO: multiple input multiple output) can enable mitigation of a jammer. Provided that the receiver knows the spatial signature of the jammer interference, MIMO signal processing can enable jammer mitigation through spatial filtering. In case of a barrage jammer, the signature is stationary and known techniques can be applied to estimate the signature. Smart jammers may deliberately suspend their activities, may continuously change their spatial signature (e.g., using time-varying beamforming), may stay unnoticeable except during specific communication parts (e.g., only active during exchange of control signals of legitimate communication), etc., and/or jammers may use multiple antennas for preventing or making it more difficult to estimate their signature and enable their mitigation.

Marti et al., Joint Jammer Mitigation and Data Detection for Smart, Distributed, and Multi-Antenna Jammers, to be presented at the 2023 IEEE International Conference on Communications (ICC), arXiv:2211.07211v2, 9 Feb. 2023, discloses to estimate and remove the jammer interference subspace jointly with detecting the transmit data over multiple time slots. Doing so removes the need for a dedicated rate-reducing training period while enabling the mitigation of smart and dynamic multi-antenna jammers.

Shen et al., MCR Decoding: A MIMO Approach for Defending Against Wireless Jamming Attacks, IEEE Conference on Communications and Network Security (CNS), 2014, (PhySec'14), discloses a Multi-Channel Ratio (MCR) Decoding with the basic idea to fully leverage the repeated preamble signals and the multi-channel characteristics in MIMO communications to detect and recover desired transmission signals under constant and reactive jamming attacks.

Marti et al., Jammer Mitigation via Beam-Slicing for Low-Resolution mmWave Massive MU-MIMO, IEEE Open Journal of Circuits and Systems, Volume 2, 2021, discloses a beam-slicing method that mitigates the impact of a permanently transmitting jammer during uplink transmission of basestations equipped with low-resolution analog-to-digital converters.

Yan et al., Jamming Resilient Communication Using MIMO Interference Cancellation, IEEE Transactions on Information Forensics and Security, Vol. 11, No. 7, Jul. 2016, discloses MIMO interference cancellation that treats jamming signals as noise and strategically cancels them out, while transmit precoding adjusts the signal directions to optimize the decoding performance.

Do et al., Jamming-Resistant Receivers for the Massive MIMO Uplink, IEEE Transactions on Information Forensics and Security, Vol. 13, No. 1, Jan. 2018, discloses a jammer attack during pilot and data transmission phases. In the pilot phase, the base station estimates not only the legitimate channel, but also the jamming channel by exploiting a purposely unused pilot sequence.

EP3211812 discloses performing rotation processing on a preset precoding matrix; performing precoding processing on to-be-sent information according to a precoding matrix obtained after the rotation processing; and sending to-be-sent information obtained after the precoding processing. In the embodiments of the present invention, indication information shared by a transmit end and a receive end is used to indicate whether to rotate a precoding matrix, and to-be-sent information is precoded according to the indication information. The transmit end and the receive end in this method learn the indication information in advance, and system security is improved by instructing the precoding matrix to perform flexible transformation.

GIAN MARTI ET AL: “Mitigating Smart Jammers in Multi-User MIMO”, ARXIV. ORG, CORNELL UNIVERSITY LIBRARY, 201 OLIN LIBRARY CORNELL UNIVERSITY ITHACA, NY 14853, 22 Dec. 2022, discloses formulation of an optimization problem that unifies jammer estimation and mitigation, channel estimation, and data detection, and exploits that a jammer cannot change its subspace within a coherence interval. DISCLOSURE OF THE INVENTION There may be a need for a transmitter, a receiver, a communication system and a communication method which improve mitigation of an interfering transmitter, such as a jammer. In particular, there may be a need for a transmitter, a receiver, a communication system and a communication method which enable mitigating of any interfering transmitter, such as a smart jammer or a multi-antenna jammer. In particular, there may be a need for a transmitter, a receiver, a communication system and a communication method which enable mitigating of any interfering transmitter with reduced signal processing complexity.

Such a need may be met with the subject-matter of the independent claims.

Advantageous embodiments are defined in the dependent claims.

Ideas underlying embodiments of the present invention may be interpreted as being based, inter alia, on the following observations and recognitions.

An aspect of the invention relates to a transmitter for MIMO communication with a receiver. The transmitter is configured to generate an embedded signal by embedding a transmit signal with a linear time-domain transformation onto a secret subspace based on a secret unitary matrix which is accessible to the transmitter and the receiver, and to transmit the embedded signal via MIMO communication having a legitimate channel matrix to the receiver. For example, based on a secret which is accessible to the transmitter and a receiver, the transmitter embeds the transmit signal with a linear time-domain transform in a secret subspace of a higher-dimensional space, wherein applying a corresponding linear time-domain transform to the receive signal at the receiver has the effects: (i) the transform raises the legitimate transmit signal from its secret subspace, and (ii) it provably transforms any interfering transmitter (e.g., a smart jammer) into a barrage interfering transmitter (e.g., a jammer having a stationary signature), thereby simplifying mitigation.

In some embodiment, the transmitter is further configured to generate the embedded signal by multiplying the transmit signal with a parallel part of the secret unitary matrix which includes a set of rows of the secret unitary matrix. In particular, the secret unitary matrix is divided into two parts that are called in the present disclosure parallel part and orthogonal part, wherein the parallel part includes a set of K rows of the secret unitary matrix, and the orthogonal part includes the remaining R=L−K rows of the secret unitary matrix, wherein the secret unitary matrix has L rows and L columns. In particular, the transmit signal is multiplied with the parallel part of the secret unitary matrix from the right thereby effecting a time domain or temporal transformation of the transmit signal across different channel uses/time slots.

In some embodiments, the transmitter is further configured to construct the secret unitary matrix based on a common random secret shared by the transmitter and the receiver, in particular in a pseudo-random manner, wherein the secret unitary matrix is constructed in the form of a unitary matrix which is uniformly distributed over the set of all unitary matrices having respective dimension.

In some embodiments, the transmit signal includes one or more of a payload signal, a pilot signal, and a control signal. For example, mitigation of jamming during exchange of control signals is enabled.

The invention further relates to a receiver for MIMO communication with one or more transmitters. The receiver is configured to: receive a receive signal which includes an embedded signal transmitted by the one or more transmitters via MIMO communication having a legitimate channel matrix to the receiver, the embedded signal being the result of embedding a transmit signal with a linear time-domain transformation onto a secret subspace based on a secret unitary matrix which is accessible to the one or more transmitters and the receiver, and process the receive signal for determining an estimate of the transmit signal, or a variable related to the transmit signal, by extracting the transmit signal from the secret subspace using the secret unitary matrix. In particular, mitigation of any intervening transmitter is enabled. In particular, mitigation of intervening transmitters having short duty-cycles or having a large number of antennas is improved. In some embodiments, a variable related to the transmit signal can be estimated, for example for enabling estimation of the legitimate channel matrix on the basis of pilot signals, or in non-coherent communications where specific information encoded in the transmit signal are estimated, and not the transmit signal itself.

In some embodiments, processing the receive signal includes multiplying the receive signal with at least a part of the secret unitary matrix.

In some embodiments, the embedded signal is the result of multiplying the transmit signal with a parallel part of the secret unitary matrix which includes a set of rows of the unitary matrix, and processing the receive signal includes multiplying the receive signal with the unitary matrix.

In some embodiments, processing the receive signal includes transforming any interfering transmitter into a barrage interfering transmitter.

In some embodiments, processing the receive signal includes idling the one or more transmitters during a first set of samples, thereby in particular enabling constructing a interfering transmitter mitigation filter.

In some embodiments, processing the receive signal includes mitigation of an interfering transmitter based on one or more of an orthogonal projection, a linear minimum mean square error estimator, and a joint jammer mitigation and data detection technique. Because the interfering transmitter is transformed into a barrage interfering transmitter, known techniques can be applied for mitigation of the interfering transmitter.

In some embodiments, the receiver is further configured to construct the secret unitary matrix based on a common random secret shared by the transmitter and the receiver, in particular in a pseudo-random manner, wherein the secret unitary matrix is constructed in the form of a unitary matrix which is uniformly distributed over the set of all unitary matrices having respective dimension.

In some embodiments, the transmit signal includes one or more of a payload signal, a pilot signal, and a control signal.

The invention further relates to a communication system comprising one or more transmitters as described, and one or more receivers as described.

The invention further relates to a communication method for MIMO communication of one or more transmitters with a receiver. The method comprises the steps of: at the one or more transmitters: generating an embedded signal by embedding a transmit signal onto a secret subspace based on a secret unitary matrix which is accessible to the one or more transmitters and the receiver, and transmitting the embedded signal via MIMO communication having a legitimate channel matrix to the receiver, and at the receiver: receiving a receive signal which includes the embedded signal, processing the receive signal for determining an estimate of the transmit signal by extracting the transmit signal from the secret subspace using the secret unitary matrix.

In some embodiments, the method further includes the steps of: at the one or more transmitters: multiplying the transmit signal with a parallel part of the secret unitary matrix which includes a set of rows of the secret unitary matrix, and at the receiver: multiplying the receive signal with at least a part of the secret unitary matrix.

### BRIEF DESCRIPTION OF THE DRAWINGS

In the following, advantageous embodiments of the invention will be described with reference to the enclosed drawings. However, neither the drawings nor the description shall be interpreted as limiting the invention.

FIG. 1 schematically shows multi-user MIMO communication which is exposed to a jamming attack.

FIG. 2 schematically shows point-to-point or single user MIMO communication which is exposed to a jamming attack.

FIG. 3 schematically shows transmitters, a receiver and a communication system for multi-user MIMO communication which enable mitigation of a jammer according to the present invention.

FIG. 4 schematically shows transmitters, a receiver and a communication system for multi-user MIMO communication which enable mitigation of a jammer according to the present invention.

FIG. 5 schematically shows a transmitter, a receiver and a communication system for point-to-point or single user MIMO communication which enable mitigation of a jammer according to the present invention.

FIG. 6 schematically shows steps of a communication method for multi-user, point-to-point or single user MIMO communication which enables mitigation of a jammer according to the present invention.

The figures are only schematic and not to scale. Same reference signs refer to same or similar features.

### MODE(S) FOR CARRYING OUT THE INVENTION

In the following, the invention is described for an interfering transmitter in the form of a jammer TXJ. However, the invention applies to all kinds of interfering transmitters interfering legitimate communication of one or more transmitters TX1, ... TXU; TX with a receiver RX via MIMO communication having a legitimate channel matrix H. For example, an interfering transmitter can relate to another communication device using other communication protocols in the same frequency band, can relate to other electromagnetic interferences, etc.

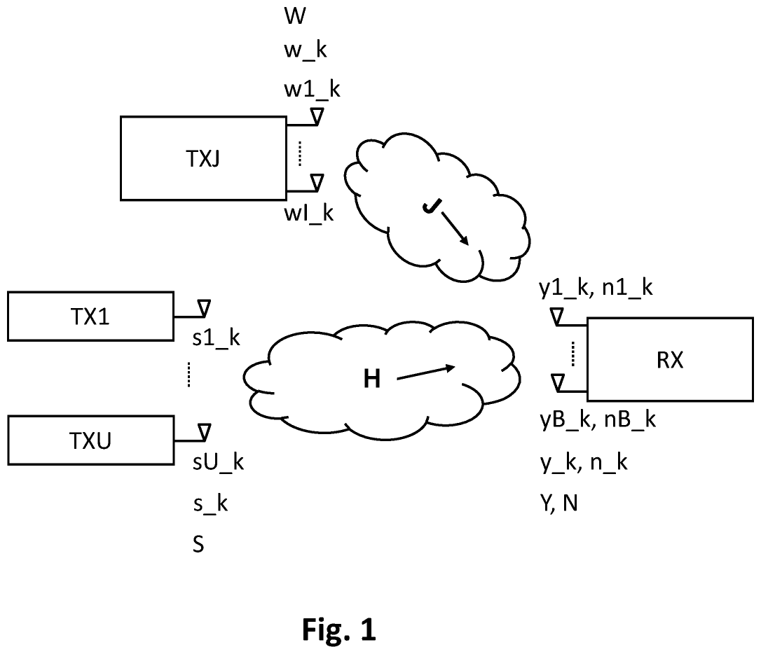

FIG. 1 schematically shows multi-user MIMO uplink communication which is exposed to a jamming attack. Transmit symbols s1_k, . . . , sU_k of U single-antenna transmitters TX1, . . . , TXU are transmitted via MIMO communication having a legitimate channel matrix H to a receiver RX. Jammer symbols w1_k, . . . , wl_k of a jammer TXJ having I antennas are transmitted via jammer channel matrix J to the receiver RX. At the receiver RX having B antennas, receive symbols y1_k, . . . , yB_k are received together with additive noise n1_k, . . . , nB_k, for example white Gaussian noise.

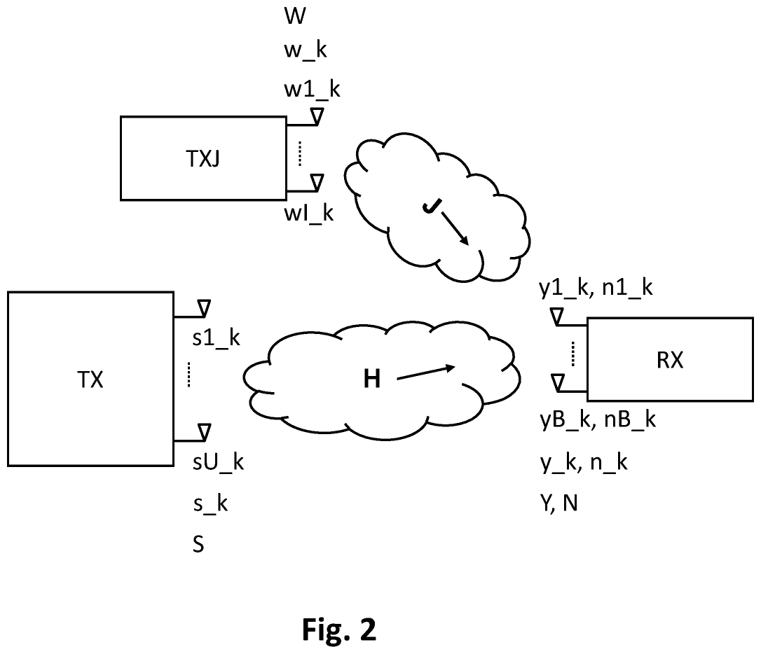

FIG. 2 schematically shows point-to-point or single user MIMO communication which is exposed to a jamming attack. Transmit symbols s1_k, . . . , sU_k of a transmitter TX having U antennas are transmitted via MIMO communication having a legitimate channel matrix H to a receiver RX. Jammer symbols w1_k, . . . , wl_k of a jammer TXJ having I antennas are transmitted via jammer channel matrix J to the receiver RX. At the receiver RX having B antennas, receive symbols y1_k, . . . , yB_k are received together with additive noise n1_k, . . . , nB_k, for example white Gaussian noise.

In the context of the present disclosure, the transmitters TX1, . . . , TXU; TX can be arranged in user equipment devices, such as smartphones, etc. The receiver RX can be arranged in a base station of a communication network, such as a 5G mobile network, etc. The transmitters TX1, . . . , TXU; TX and the receiver RX can be arranged vice-versa. The transmitters TX1, . . . , TXU; TX and the receiver RX can be arranged in other devices.

According to the present invention, transmitters TX1, . . . , TXU; TX and a receiver RX are configured to enable mitigation of a jammer as further described below. In particular, the transmitters TX1, . . . , TXU; TX and the receiver RX are configured to execute various signal processing steps for enabling mitigation of a jammer as further described below. Signal processing steps can include arithmetic operations, such as addition, subtraction, multiplication, division, etc. of numbers, in particular of complex numbers. Signal processing steps can include operations on vectors and matrices, such as multiplication of a matrix with a vector, multiplication of a matrix with another matrix, building an inverse of a matrix, building a transpose of a matrix, building a conjugate transpose of a matrix, etc. In order to enable required signal processing steps, the receiver RX and the transmitters TX1, . . . , TXU; TX can include one or more programmable processors, such as a microcontroller, and software instructions, such as machine instructions of the microcontroller, for controlling the programmable processors to execute required signal processing steps. The receiver RX and the transmitters TX1, . . . , TXU; TX can include hardwired logic circuits, such as application-specific integrated circuits and/or field programmable gate arrays, to enable required signal processing steps. The receiver RX and the transmitters TX1, . . . , TXU; TX can include any combination of one or more programmable processors, software instructions and hardwired logic circuits to enable required signal processing steps. The transmitters TX1, . . . , TXU; TX and the receiver RX can include data storages, such as volatile and/or non-volatile memories, for storing input signals of required signal processing steps and their output signals, for storing signal processing parameters, for storing vectors, matrices, etc., etc.

The transmitters TX1, . . . , TXU; TX are configured to process a transmit signal s1, . . . , sU; S and to transmit the processed transmit signal via MIMO communication having a legitimate channel matrix H to a receiver RX. The receiver RX is configured to receive a receive signal Y, which includes the processed transmit signal transmitted via the legitimate channel matrix H and can include a jammer signal as well as noise, and to process the receive signal Y for determining an estimate ~S of the transmit signal S.

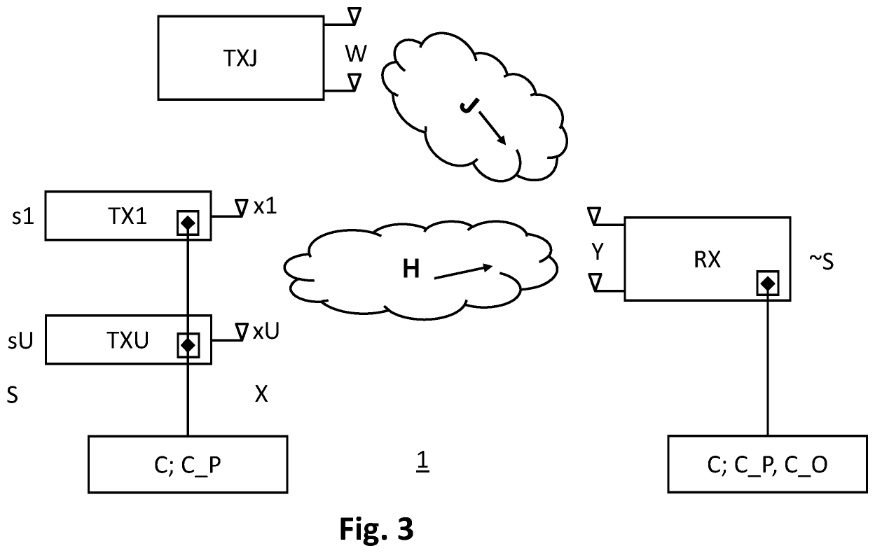

FIG. 3 schematically shows U transmitters TX1, . . . , TXU, a receiver RX and a communication system 1 for a multi-user MIMO uplink according to FIG. 1, which enable mitigation of a jammer according to the present invention as further described below. A secret unitary matrix C is accessible to the transmitters TX1, . . . , TXU and the receiver RX.

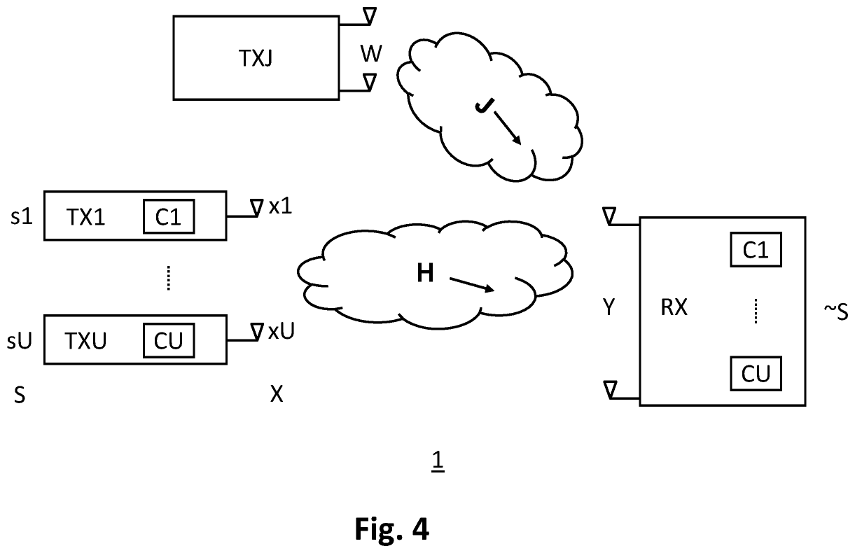

FIG. 4 schematically shows U transmitters TX1, . . . , TXU, a receiver RX and a communication system 1 for a multi-user MIMO uplink according to FIG. 1, which enable mitigation of a jammer according to the present invention as further described below. Each of the transmitters TX1, . . . , TXU has access to a respective secret unitary matrix C1, . . . , CU, which are also accessible to the receiver RX.

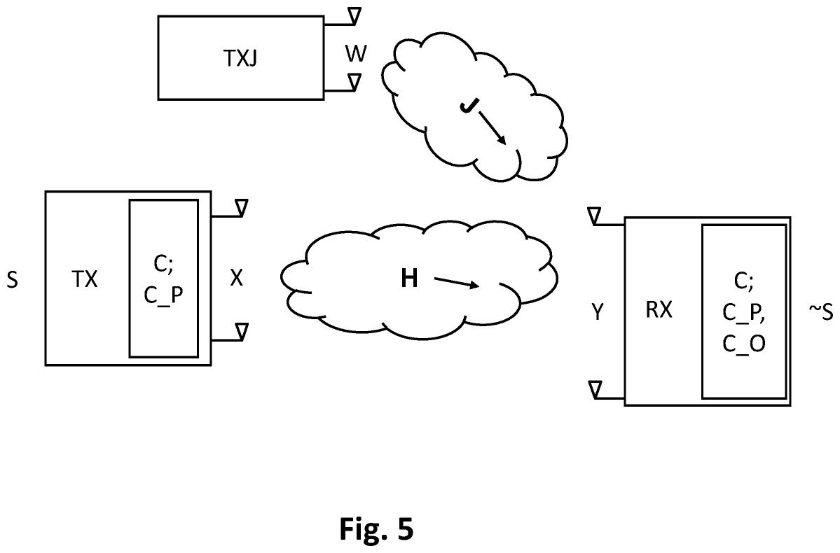

FIG. 5 schematically shows a transmitter TX, a receiver RX and a communication system 1 for a point-to-point or single user MIMO uplink according to FIG. 2, which enable mitigation of a jammer according to the present invention as further described below. A secret unitary matrix C is accessible to the transmitter TX and the receiver RX.

In the following, with reference to FIG. 3, the transmitters TX1, . . . , TXU, the receiver RX and the communication system 1 for mitigation of a jammer according to the present invention are described. Transmitters, receivers and communication systems for mitigation of a jammer in other MIMO contexts, such as illustrated in FIG. 4 and FIG. 5, can be designed in accordance with the present invention.

For a matrix A, the transpose is A\hat{ }T, the conjugate transpose is A\hat{ }H, the submatrix of columns n through m is A_[n:m], the columnspace is col(A), and the inverse is A\hat{ }−1. The NxN identity matrix is I_N. The KxR zero matrix is 0_KxR.

With reference to FIGS. 1, 2, at sample instant k, transmit vector s_k denotes the transmit symbols s1_k, . . . , sU_k transmitted by the transmitters TX1, . . . , TXU, jammer vector w_k denotes the jammer symbols w1_k, . . . , wl_k transmitted by the jammer TXJ, receive vector y_k denotes the receive symbols y1_k, . . . , yB_k received at the receiver RX, noise vector n_k denotes the noise symbols n1_k, . . . , nB_k received at the receiver RX (for example, white Gaussian noise with per-entry variance N_0). H denotes the legitimate channel matrix with dimension BxU of MIMO communication of single-antenna transmitters TX1, . . . , TXU with the receiver RX (the number of single-antenna transmitters TX1, . . . , TXU is U; the number of antennas of the receiver RX is B). J denotes the jammer channel matrix with dimension Bxl of jammer communication of a jammer TXJ with the receiver RX (the number of antennas of the jammer TXJ is I). Vectors s_k, w_k, n_k, y_k and matrices H, J can contain complex numbers, which also applies to further vectors and matrices as described in the present disclosure.

For a frequency-flat transmission mode, the receive vector y_k received at receiver RX amounts to: y_k=Hs_k+Jw_k+n_k.

For transmission frames of length L, the receive signal Y received at the receiver RX amounts to: Y=HS+JW+N, wherein the receive signal Y=[y_1, . . . , y_L] has dimension BxL, the transmit signal S=[s_1, . . . , s_L] has dimension UxL, the jammer signal W=[w_1, . . . , w_L] has dimension IxL, and the noise signal N=[n_1, . . . , n_L] has dimension BxL.

For example, the jammer TXJ can dynamically change its jamming activity.

Specifically, the jammer TXJ can transmit vector w_k=A_k~w_k, wherein ~w_k has a covariance matrix which is the identity matrix of dimension L for all k, and wherein A_k is a beamforming matrix which changes arbitrarily as a function of k. For example, A_k can sometimes be the all-zero matrix (the jammer temporarily suspends jamming), some of its rows can be zero (the jammer TXJ temporarily uses only a subset of its antennas), or it can be rank-deficient in some other way. For example, no assumptions or restrictions about the abilities of the jammer TXJ apply. For example, the number I of antennas of the jammer TXJ is smaller than the number B of the antennas of the receiver RX.

With reference to FIG. 3, the transmitters TX1, . . . , TXU according to the present invention are configured to generate an embedded signal X by embedding a transmit signal S onto a secret subspace subC based on the secret unitary matrix C which is accessible to the transmitters TX1, . . . , TXU and the receiver RX, and to transmit the embedded signal X via MIMO communication having a legitimate channel matrix H to the receiver.

Thus, taking into account arbitrary activity of the jammer TXJ and noise, the receive signal Y received at receiver RX amounts to: Y=HX+JW+N.

With reference to FIG. 3, the receiver RX according to the present invention is configured to process the receive signal Y and to determine an estimate ~S of the transmit signal S by extracting the transmit signal S from the secret subspace subC using the secret unitary matrix C.

The transmitters TX1, . . . , TXU and the receiver RX are configured to access a secret unitary matrix C. The secret unitary matrix C can be based on a secret that is shared by the transmitters TX1, . . . , TXU and the receiver RX, for example a shared random secret. The transmitters TX1, . . . , TXU and the receiver RX can be configured to construct based on this secret in pseudo-random manner the secret unitary matrix C, wherein the secret unitary matrix C is uniformly distributed over the set of all unitary LxL matrices. For example, the secret unitary matrix C can be constructed as disclosed in Meckes, The random matrix theory of the classical compact groups, Cambridge University Press, 2019, vol. 218, Section 1.2. The secret unitary matrix C has dimension LxL.

For example, the secret unitary matrix C can be constructed as follows: 1. A shared secret is used as random seed for subsequent pseudorandom routines. 2. A LxL matrix M is constructed (based on the random seed) by i.i.d. (i.i.d.: independent and identically distributed) drawing its entries from a pseudorandom complex unit-variance circularly-symmetric normal distribution CN(0,1). 3. The matrix M is then decomposed using the Gram-Schmidt procedure into the QR-decomposition, M=Q*R, where Q is unitary and R is upper-triangular. 4. Then the obtained matrix Q is Haar distributed and can be identified with the matrix C: C=Q. 5.

For example, the secret unitary matrix C can be constructed in the form of an approximately unitary matrix, e.g., for the purpose of a more efficient implementation.

For example, the secret unitary matrix C can be multiplied by a scalar and the secret unitary matrix C multiplied by the scalar can be used as the secret unitary matrix C.

The transmitters TX1, . . . , TXU and the receiver RX are configured to divide the secret unitary matrix C into a parallel part C_P and into an orthogonal part C_O. The parallel part C_P of the secret unitary matrix C includes a set of K rows of the secret unitary matrix C, and the orthogonal part C_O of the secret unitary matrix C includes the remaining R=L−K rows of the secret unitary matrix C, such that the following holds true: C=[C_O; C_P], wherein the parallel part C_P has dimension KxL, wherein the orthogonal part C_O has dimension RxL, and wherein K+R=L. The number R can be called redundancy. For example, the redundancy R is at least as big as the dimension of the interference: R>=rank(JW).

The transmitters TX1, . . . , TXU are configured to generate the embedded signal X by multiplying a length-K transmit signal S with dimension UxK with the parallel part C_P of the secret unitary matrix C, namely: X=SC_P. With reference to FIG. 3, no cooperation between the transmitters TX1, . . . , TXU is required, as the u-th transmitter TXu simply computes the (transpose of the) u-th row of the embedded signal X by multiplying the (transpose of the) u-th row of the transmit signal S with the parallel part C_P. The embedded signal X has dimension UxL.

For example, the secret unitary matrix C is constructed such that embedding a transmit signal S onto a secret subspace subC which is uniformly districuted is enabled.

For example, the transmit signal S can include a payload signal SD, a pilot signal ST, a control signal SC, and/or a signal of any other kind. The payload signal SD can relate to actual, intended information to be communicated from the transmitters TX1, . . . , TXU to the receiver RX, such as messages, speech data, video data, etc. The pilot signal ST can relate to signals for channel estimation of the MIMO channel matrix H, such as an orthogonal matrix having dimension UxU that results from stacking U transmitter pilot sequences together. The control signal SC can relate to signals for controlling operation of the transmitters TX1, . . . , TXU, the receiver RX, and/or any other equipment. For example, the payload signal SD can additionally or alternatively include signals for controlling operation of the transmitters TX1, . . . , TXU, the receiver RX, and/or any other equipment.

The receiver RX is configured to receive a receive signal Y, which includes the embedded signal X and the jammer signal W and noise N as follows: Y=HX+JW+N=HSC_P+JW+N. The jammer signal W is independent of the secret unitary matrix C, since the jammer TXJ does not know the secret unitary matrix C. No further assumptions about the jammer signal W apply. For example, the jammer signal W can depend on the legitimate MIMO channel matrix H and the jammer channel matrix J (the jammer can have full knowledge about the channels). For example, the jammer signal W can depend on the transmit signal S (the jammer can know the signal to be transmitted).

The receiver RX is configured to process the receive signal Y by multiplying the receive signal Y with the secret unitary matrix C. In particular, the receiver is configured to apply the following processing step: Y_C=YC\hat{ }H. The raised receive signal Y_C amounts to: Y_C=HSC_PC\hat{ }H+JWC\hat{ }H+NC\hat{ }H=HS[O_KxR, I_K]+JW_C+N_C=[O_BxR, HS]+JW_C+N_C, wherein the equality C_PC\hat{ }H=[0_KxR, I_K] follows from the unitarity of the secret unitary matrix C=[C_P; C_O].

Thus, the receiver RX obtains an input-output relation where the channels H and J are unchanged, where the transmitters TX1, . . . , TXU are idle for the first R samples and transmit the transmit signal S in the remaining samples. The jammer transmits the raised jammer signal W_C=WC\hat{ }H. The raised noise N_C=NC\hat{ }H is i.i.d. circularly-symmetric complex Gaussian noise with variance N_0.

The interference of a jammer TXJ is JW. The rank of the interference I*, namely rank(JW), is the dimension of the interference space. Depending on the jammer's transmit beamforming, the dimension of the interference space can be equal or strictly smaller than the number of antennas I. The compact singular value decomposition (SVD) of the interference JW amounts to: JW=FEV\hat{ }H. Matrix F has dimension Bxl* and is the spatial scope of the jammer TXJ. Its columns are an orthonormal basis of the interference space in the spatial domain. Matrix V has dimension Lxl* and is the temporal extension of the jammer TXJ in a frame. Its columns are an orthonormal basis of the interference space in the time domain.

Matrix Σ is quadratic diagonal and is the energy profile diag(Σ)=[g1, . . . , gl*]\hat{ }T with g1>=. . . >=gl*>=0 of the jammer. It determines how much energy the jammer TXJ allocates to the different dimensions in space and time.

A barrage jammer is a jammer for which the columns of V are distributed uniformly over the complex L-dimensional unit sphere. For example, a jammer that transmits W with entries drawn i.i.d. from a complex normal distribution CN(0; 1) is a barrage jammer. For example, a jammer that transmits W=aw\hat{ }T, with w ~CN(0,1_B), and with a having I complex numbers is a barrage jammer. Barrage jammers are fully characterized by their spatial scope F and their energy profile diag(2).

It can be shown that the raised jammer interference JW_C relates to a barrage jammer (e.g., the signature is stationary) for any jammer interference JW (e.g., of a smart jammer that changes its spatial signature). Thus, the receiver RX transforms any jammer into a barrage jammer with identical spatial scope and identical energy profile. In particular, the receiver RX transforms any jammer into the (unique) barrage jammer with identical spatial scope and identical energy profile. Furthermore, the receiver RX conveniently transforms the legitimate transmit signal S: during the first R samples, the transmitters TX1, . . . , TXU are idle and then transmit the transmit signal S (in case the orthogonal part C_O includes the first R rows of the secret unitary matrix C and the parallel part C_P includes the subsequent K rows of the secret unitary matrix C). The receiver RX can therefore use the first R columns of the raised receive signal Y_C as a jammer training period for constructing a jammer mitigation filter that is effective for the whole frame. The remaining columns of the raised receive signal Y_C correspond to the transmit signal S, which can be recovered using the jamming mitigation filter obtained during the training period.

Various techniques can be applied for obtaining the jamming mitigation filter. In coherent data transmission, the transmit signal S includes orthogonal pilot signals ST having dimension UxU and payload signals SD (the data symbols to be transmitted) from a constellation of complex numbers (e.g., 16 QAM) having dimension Ux(K-U), which amounts to: S=[ST, SD]. The raised receive signal Y_C can be divided into a jammer part Y_C,J, a pilot part Y_C, T, and a payload part Y_C,D, which amount to:
Y_C,J=JW_C,J+N_j having dimension B×R,
Y_C, T=HST+JW_C, T+N_T having dimension B×U,
Y_C,D=HSD+JW_C, D+N_D having dimension B×(K−U).

A first technique to mitigate a jammer relates to orthogonal projection. Y_C,J includes samples of a barrage jammer corrupted by white Gaussian noise N_J, but not any signals of the transmitters TX1, . . . , TXU. This can be used to estimate the projection onto the orthogonal complement of the jammer's spatial scope, which is given by the I* leading left-singular vectors F=[f1, . . . , fl*] (having dimension Uxl*) of Y_C,J. The corresponding projection matrix is therefore: Q=I_B-FF\hat{ }H, which can be used to mitigate the jammer in the pilot phase and payload phase as:
Y_Q, T=QY_C, T=QHST+QJW_C, T+QN_C, T
~H_QST+N_Q, T, because QJW_C, T=0, wherein H_Q=QH, N_Q, T=QN_C, T, and
Y_Q, D=QY_C,D=QHSD+QJW_C, D+QN_C, D
~H_QSD+N_Q, D.

For example, I* can alternatively be determined by counting the number of singular values that exceed n times the square root of B times N_0, where n>1 is a threshold parameter that can be chosen freely and the square root of B times N_0 is the expected value of the singular values due to noise.

The receiver RX thus obtains an input-output relation that is jammer-free and consists of a virtual channel H_Q which is corrupted by Gaussian noise with spatial distribution CN(0, N_0Q). Using least squares (LS), the receiver RX can estimate the virtual channel H_Q, which amounts to: ~H_Q=Y_Q, TS_T\hat{ }H. The payload signal SD can be detected using, e.g., a classical LMMSE detector, which amounts to: ~SD=(~H_Q\hat{ }H~H_Q+N_01_U)\hat{ }−1~H_Q\hat{ }HY_Q, D.

A second technique to mitigate a jammer relates to LMMSE equalization. The orthogonal projection described previously is highly effective, but requires the computation of a singular value decomposition (of Y_C,J) and the explicit estimation of the jammer interference dimension I *. A LMMSE-type equalizer can be applied, based on an estimate of the jammer's spatial covariance matrix cov_J=E[JW_C(JW_C)\hat{ }H], which can be obtained as follows: ~cov_J=(1/R)Y_C,JY_C,J\hat{ }H. The LMMSE estimate of legitimate MIMO channel H can be determined based on the pilot phase: ~H=(I_B+(1/U)~cov_J)\hat{ }−1Y_C, TS_T\hat{ }H, and the LMMSE estimate of the payload signal SD can be determined based on the payload phase: ~SD=~H\hat{ }H(~H~H\hat{ }H+N_01_B+~cov_J)\hat{ }−1Y_C,D.

Accordingly, calculation of a singular value decomposition can be avoided. However, inversion of two matrices of size BxB is required, as opposed of inverting a single matrix of size UxU. This can be avoided using matrix identities:
~H=(_B−Y_C,J(URI_R+Y_C,J\hat{ }HY_C,J)\hat{ }−1Y_C,J\hat{ }H)Y_C, TST\hat{ }H,
A1=[~H\hat{ }H; (1/sqrt(R))Y_C,J\hat{ }H],
A=(N_01_U+R+A1[~H, (1/sqrt(R))Y_C,J)\hat{ }−1A1,
~SD=A_[1:U]Y_C,D.

Accordingly, only inversion of a matrix of size RxR and a matrix of size (U+R)×(U+R) is required, contrary to the orthogonal projection technique which requires a singular value decomposition of a matrix of size BxL and inversion of a matrix of size UxU.

A third technique to mitigate a jammer relates to joint jammer mitigation and data detection (JMD), which is a novel paradigm for smart jammer mitigation in which the jammer subspace is estimated and nulled (with an orthogonal projection) jointly with detecting the transmit data over an entire transmission frame, cf. Marti et al., Mitigating smart jammers in multi-user MIMO, IEEE Trans. Signal Process., vol. 71, pp. 756-771, 2023; Marti et al., Joint jammer mitigation and data detection for smart, distributed, and multi-antenna jammers, to be presented at the 2023 IEEE International Conference on Communications (ICC), arXiv:2211.07211v2, 9 Feb. 2023, pp. 1-6.

JMD operates by approximately solving a non-convex optimization problem, and can have excellent performance even without any jammer training period (R=0). However, JMD may (i) perform poorly against jammers with a very short duty cycle, (ii) require the dimension of the jammer interference as side information, and (iii) not reliably converge to the correct solution against jammers with a large number of antennas.

All these issues can be substantially alleviated if JMD is combined with the invention according to the present disclosure: (i) the invention according to the present disclosure transforms jammers with short duty cycles into fully non-sparse barrage jammers, (ii) in combination with non-zero redundancy (R>0), Y_C,J can be used to estimate the dimension of the jammer interference, and (iii) Y_C,J can be used for optimal problem initialization to improve performance against high-dimensional jammers.

As an example, the optimization problem to be solved if the JMD method MAED as disclosed in Marti et al., Mitigating smart jammers in multi-user MIMO, IEEE Trans. Signal Process., vol. 71, pp. 756-771, 2023 is enhanced with the invention according to the present disclosure.

The optimization problem is to minimize over ~Q, ~H_Q, ~SD the Frobenius norm: abs(~Q[Y_Q, T, Y_Q, D]−~H_Q[ST,] SD])\hat{ }2.

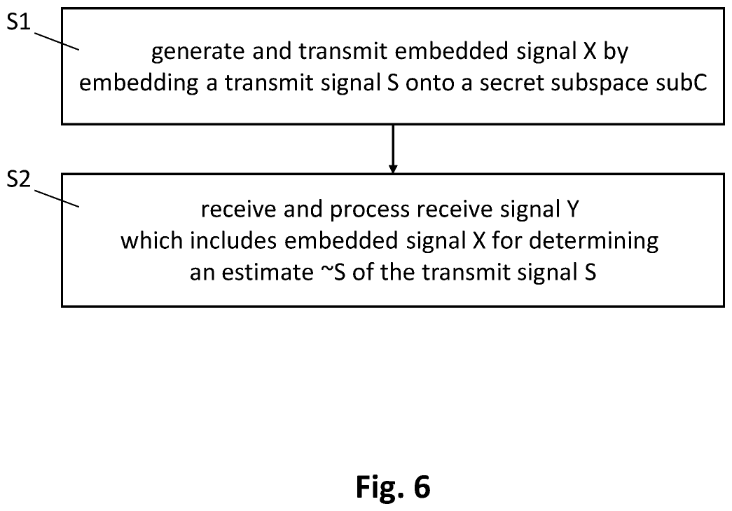

Optimization of ~Q is over the (B-I*)-dimensional Grassmannian manifold. According to the present invention, I* can be estimated from Y_C,J, for example as the number of singular values that significantly exceed the threshold sqrt(B N_0) which is expected due to thermal noise, and ~Q can be initialized to I_B-FF~H based on Y_C,J. FIG. 6 schematically shows steps of a communication method for multi-user, point-to-point or single user MIMO communication which enables mitigation of a jammer according to the present invention. In step S1, at one or more transmitters TX1, . . . , TXU; TX, an embedded signal X is generated by embedding a transmit signal S onto a secret subspace subC based on a secret unitary matrix C; C1, . . . , CU which is accessible to the one or more transmitters TX, . . . , TXU; TX and a receiver RX, and the embedded signal X is transmitted via MIMO communication having a legitimate channel matrix H to the receiver RX. In step S2, at the receiver RX, a receiver signal Y is received which includes the embedded signal X, and the receive signal Y is processed for determining an estimate ~S of the transmit signal S by extracting the transmit signal S from the secret subspace subC.

Possible extensions of the disclosed subject matter include:

Prior Knowledge: For instance at so-called millimeter-wave (mmWave) frequencies, channels are known to exhibit sparsity in the so-called beamspace domain. This could be incorporated with a sparsity-promoting signal prior on the jammer channel J in the beamspace domain.

Nonlinear data detectors: Any kind of data detectors (including non-coherent data detectors, i.e., detectors that do not need knowledge of the channel matrix H) would be possible. This includes e.g. the detectors from Marti et al., Multiuser MIMO Detection With Composite NUV Priors, 2021; Castañeda et al., Data detection in large multi-antenna wireless systems via approximate semidefinite relaxation, 2016; Jeon et al. Optimality of large MIMO detection via approximate message passing, 2015; or the joint jammer mitigation and data detection (JMD) method outlined above.

Finally, it should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.
LIST OF REFERENCE SIGNS
TX1, . . . , TXU; TX transmitter(s)
s1, . . . , sU; S transmit signal
SD payload signal; ST pilot signal; SC control signal
x_1, . . . , x_U; X embedded signal
H legitimate MIMO channel matrix
TXJ jammer, interfering transmitter
W jammer signal, interfering signal
J jammer channel matrix, interfering channel matrix
RX receiver
Y receive signal
N noise signal
C; C1, . . . , CU secret unitary matrix(ces)
C_P parallel part of secret unitary matrix
C_O orthogonal part of secret unitary matrix
subC secret subspace
subJ jammer subspace, interfering subspace
~S estimate of transmit signal
~SD estimate of payload signal

1. A transmitter for MIMO communication with a receiver, the transmitter being configured to:
generate an embedded signal by embedding a transmit signal with a linear time-domain transformation onto a secret subspace based on a secret unitary matrix which is accessible to the transmitter and the receiver and
transmit the embedded signal via MIMO communication having a legitimate channel matrix to the receiver.

2. The transmitter according to claim 1, further configured to generate the embedded signal by multiplying the transmit signal with a parallel part of the secret unitary matrix which includes a set of rows of the secret unitary matrix.

3. The transmitter according to claim 1, further configured to construct the secret unitary matrix based on a common random secret shared by the transmitter and the receiver, in particular in a pseudo-random manner, wherein the secret unitary matrix is constructed in the form of a unitary matrix which is uniformly distributed over the set of all unitary matrices having respective dimension.

4. The transmitter according to claim1 , wherein the transmit signal includes one or more of a payload signal a pilot signal, and a control signal.

5. A receiver for MIMO communication with one or more transmitters the receiver being configured to:
receive a receive signal which includes an embedded signal transmitted by the one or more transmitters, via MIMO communication having a legitimate channel matrix to the receiver, the embedded signal being the result of embedding a transmit signal with a linear time-domain transformation onto a secret subspace based on a secret unitary matrix which is accessible to the one or more transmitters and the receiver, and
process the receive signal for determining an estimate of the transmit signal, or a variable related to the transmit signal, by extracting the transmit signal from the secret subspace using the secret unitary matrix

6. The receiver according to claim 5, wherein processing the receive signal includes multiplying the receive signal with at least a part of the secret unitary matrix.

7. The receiver according to claim 5, wherein the embedded signal is the result of multiplying the transmit signal with a parallel part of the secret unitary matrix which includes a set of rows of the unitary matrix and wherein processing the receive signal includes multiplying the receive signal with the unitary matrix.

8. The receiver according to claim 5, wherein processing the receive signal includes transforming any interfering transmitter into a barrage interfering transmitter.

9. The receiver according to claim 5, wherein processing the receive signal includes idling the one or more transmitters during a first set of samples, thereby in particular enabling constructing a interfering transmitter mitigation filter.

10. The receiver according to claim 5, wherein processing the receive signal includes mitigation of an interfering transmitter based on one or more of an orthogonal projection, a linear minimum mean square error estimator, and a joint jammer mitigation and data detection technique.

11. The receiver according to claim 5, further configured to construct the secret unitary matrix based on a common random secret shared by the transmitter and the receiver, in particular in a pseudo-random manner, wherein the secret unitary matrix is constructed in the form of a unitary matrix which is uniformly distributed over the set of all unitary matrices having respective dimension.

12. The receiver according to claim 5, wherein the transmit signal includes one or more of a payload signal, a pilot signal and a control signal.

13. A communication system comprising:
one or more transmitters being configured to:
generate an embedded signal by embedding a transmit signal with a linear time-domain transformation onto a secret subspace based on a secret unitary matrix which is accessible to the transmitter and the receiver, and
transmit the embedded signal via MIMO communication having a legitimate channel matrix to the receiver; and
one or more receivers being configured to:
receive a receive signal which includes an embedded signal transmitted by the one or more transmitters-via MIMO communication having a legitimate channel matrix to the receiver, the embedded signal being the result of embedding a transmit signal with a linear time-domain transformation onto a secret subspace based on a secret unitary matrix which is accessible to the one or more transmitters and the receiver, and
process the receive signal for determining an estimate of the transmit signal, or a variable related to the transmit signal, by extracting the transmit signal from the secret subspace using the secret unitary matrix.

14. A communication method for MIMO communication of one or more transmitters with a receiver the method comprising the steps of:
at the one or more transmitters
generating an embedded signal by embedding a transmit signal onto a secret subspace based on a secret unitary matrix which is accessible to the one or more transmitters and the receiver, and
transmitting the embedded signalvia MIMO communication having a legitimate channel matrix to the receiver, and at the receiver
receiving a receive signal which includes the embedded signal,
processing the receive signal for determining an estimate of the transmit signal, or a variable related to the transmit signal, by extracting the transmit signal from the secret subspace using the secret unitary matrix.
